(19) United States
(12) Patent Application Publication
(10) Pub. No.: US 2017/0072476 A1
(43) Pub. Date: Mar. 16, 2017

(54) Spring Loading Insert

(71) Applicant: Hugh Prescott Baird, Upland, CA (US)

(72) Inventor: Hugh Prescott Baird, Upland, CA (US)

(21) Appl. No.: 14/810,463

(22) Filed: Jul. 27, 2015

(51) Int. Cl. B23B 31/08

(52) U.S. Cl. CPC B23B 31/083; B23B 2231/04; B23B 2231/22

(57) ABSTRACT

Spring loading insert comprising an insert, spring, and set screw or sleeve and snap ring for retention into a tool holder, which when installed into a tool holder, uses the tool holder tool pocket as the outer shell of the tool, making the tool holder part of the tool itself. By doing this and by having a wide verity of choices of outside diameters for the insert and not only tool pocket diameters but tool connection methods make this a vary versatile and inexpensive way to spring load a tool.

### FIELD OF THE INVENTION

The present invention relates to C.N.C. and manual milling machines and, more particularly, to tool holders.

### BACKGROUND OF THE INVENTION

Engine turning is a form of metal decorating where a fine geometric or repeating pattern is inscribed onto metal as a finish treatment, often consisting of hundreds if not thousands of overlapping circular swirls. To achieve a consistent result in the appearance, depth, and size of the swirls requires constant pressure of an abrasive tool on the surface of the metal. Which due to the abrasive tool wearing down, and uneven surfaces is difficult to archive with a rigidly fixed tool, with a fixed z depth, or when trying to approximate abrasive tool wear and trying to program z depth changes accordingly, or when using a manual mill and trying to pull down on the z axes handle evenly every time. By using a spring loading insert and by setting the z below the actual surface of the material the spring can deliver consistent pressure. By changing the spring and spring rate the spring loading insert can be fine tuned for the pressure needed for the material, tool used, and results desired.

### SUMMARY OF THE INVENTION

In accordance with the present invention, there is provided. . . . Spring loading insert comprising an insert, spring, and set screw or sleeve and snap ring for retention into a tool holder, which when installed into a tool holder, uses the tool holder tool pocket as the outer shell of the tool, making the tool holder part of the tool itself. By doing this and by having a wide verity of choices of outside diameters for the insert and not only tool pocket diameters but tool connection methods make this a very versatile and inexpensive way to spring load a tool, whether it be for engine turning, burnishing, engraving, and engraving on uneven surfaces, etching metal with the spindle off, just using the X,Y and Z drives.

It would be advantageous to provide a spring loaded drill bit holder when manually controlling a motor driven z axis with no tactile feel to the operator. The spring would give a little lee way and prevent breaking the bit by going into the material too quickly.

It would be also be advantageous because of being a vary low cost way of being able to spring load a tool holder that most machine owners already have, use it, and remove it, with no damage to tool holder tool pocket inside diameter.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of an embodiment of the invention assembled and installed into a tool holder;

FIG. 2 is a front, side,and back detail view of an embodiment of the invention assembled and outside of tool holder;

FIG. 3 is an exploded front and side view of an embodiment of the invention showing the order of assembly into a tool holder;

FIG. 4 is a front, side, and back detail view of an alternative embodiment of invention utilizing a pin style set screw;

FIG. 5 is a front and side detail view of an alternative embodiment of the invention utilizing a sleeve and snap ring for retention into a r8 tool holder;

FIG. 6 is an exploded front and side view of an alternative embodiment of the invention showing the order of assembly into a r8 tool holder and utilizing a sleeve, a snap ring,and a snap ring slot for retention into tool holder; and

FIG. 7 is a perspective view of an alternative embodiment of the invention utilizing a sleeve and snap ring for retention, assembled into a r8 tool holder.

For purposes of clarity and brevity, like elements and components will bear the same designations and numbering throughout the Figures.

### DESCRIPTION OF THE PREFERRED EMBODIMENT

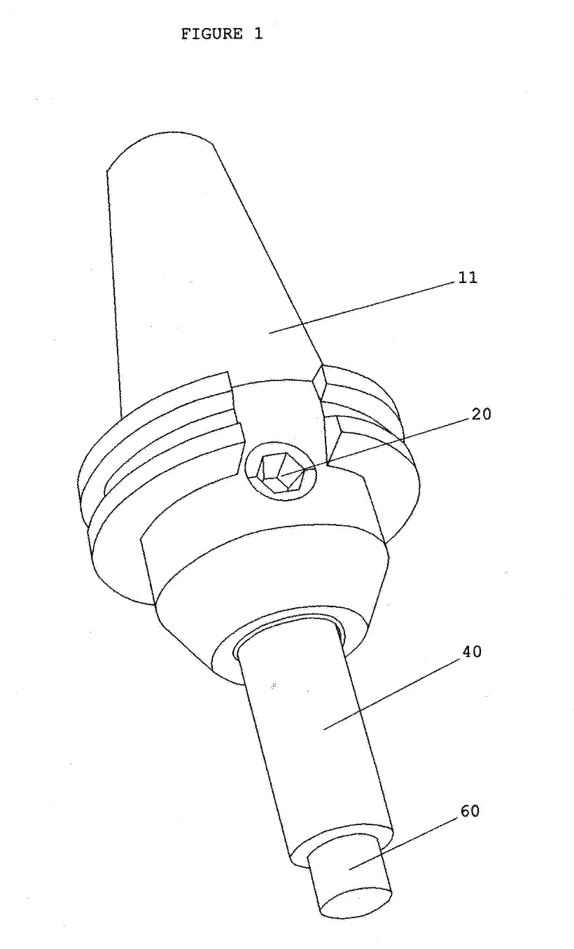

FIG. 1 is a embodiment of the invention with tool 60 installed and assembled into tool holder 11

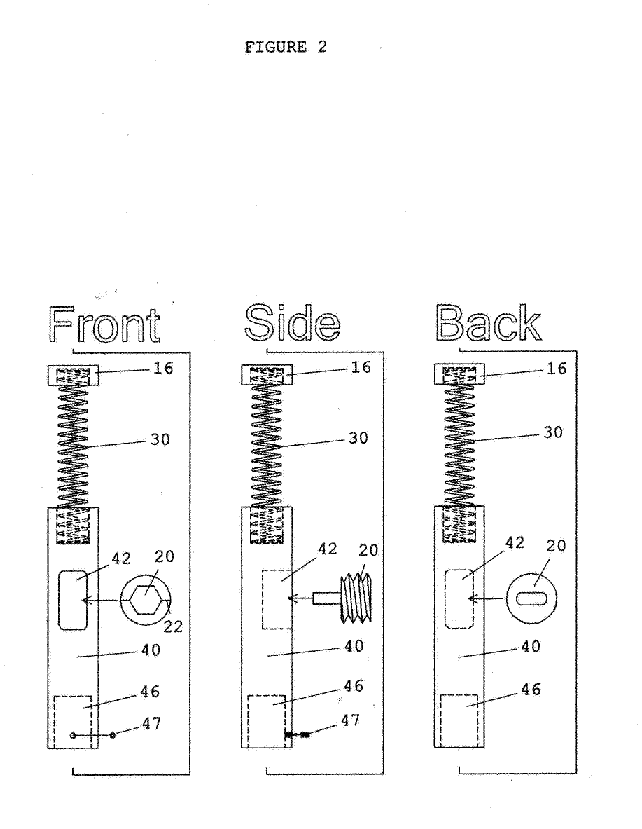

FIG. 2 is a front, side and back detail view of an embodiment of the invention, utilizing a compression spring 30 of varying size and rebound rates depending upon the tool 60 that will be used, and the outward pressure desired.

The insert 40 is machined from a phenolic rod because of it's strength, wear resistance, and slippery nature, but can also be manufactured using materials such as oil filled bearing bronze, aluminum, wood, plastic, or other material that is softer than the steel that the tool holder 11 is made of, so as not to cause undo wear to the tool holder tool pocket 62.

The end of the set screw 20 utilizes a oblong tab that has been machined on the one end that protrudes into the insert set screw pocket 42 and controls the in and out travel of the insert 40.

The oblong tab on the end of the set screw 20 is the preferred method of retention of insert 40 into tool holder 11 because it can be screwed in loosely to allow movement of insert 40, but the flat side design of the oblong prevents the set screw 20 from backing out of the tool holder 11.

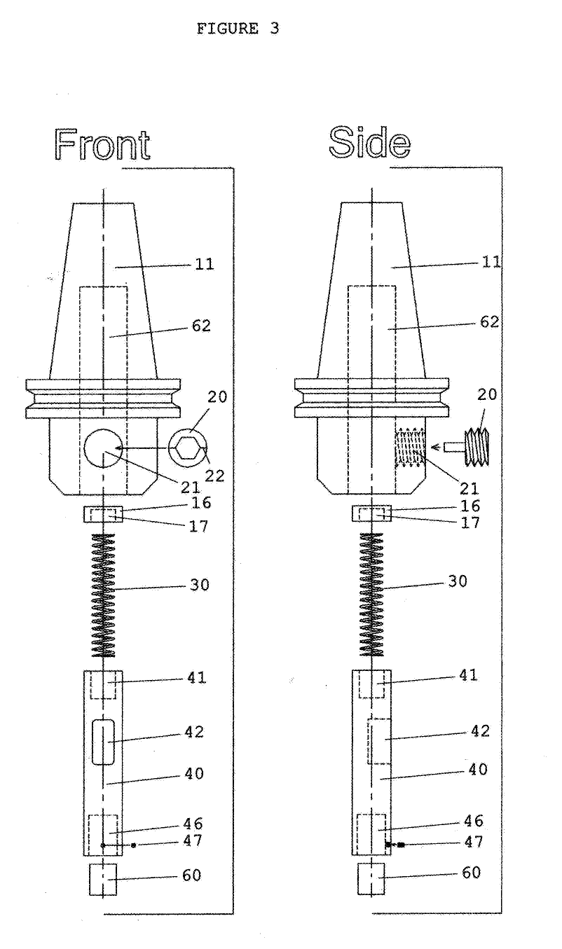

FIG. 3 is an exploded front and side view of an embodiment of the invention showing the order of assembly into a tool holder 11. To assemble, start with the spring stop 16, if needed, which is pushed up to the top of the tool holder tool pocket 62 followed by the spring 30 and than the insert 40. Lining up the insert tool pocket 46 and set screw hole 21 and using the palm of your hand, press insert 40 into tool holder 11 until able to install set screw 20 by screwing into spindle until snug against back of insert set screw pocket 42, than back the set screw 20 out approximately ½ turn until the positioning line 22 is perpendicular to the side the insert 40 allowing full movement of insert 40. Than the tool 60 can be installed into the insert tool pocket 46 and secured with insert tool pocket set screw 47,

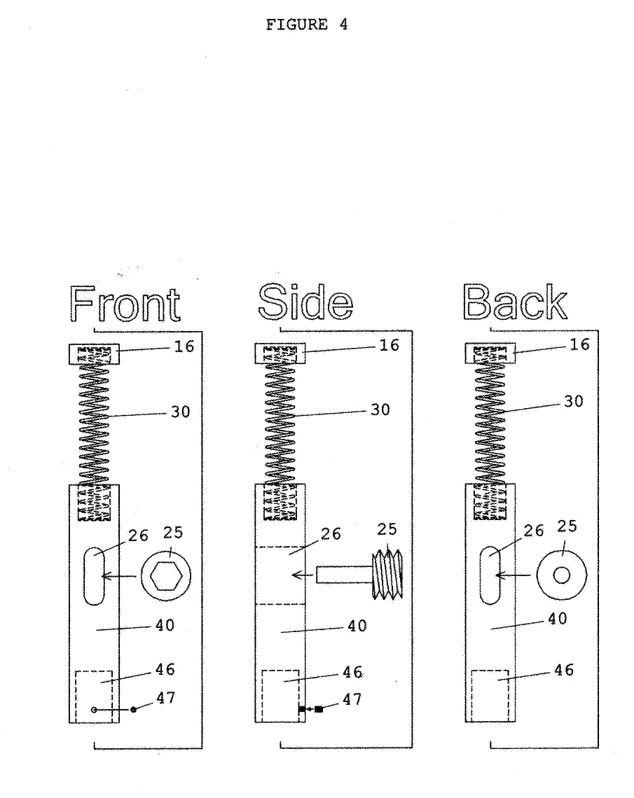

FIG. 4 is a front, side, and back detail view of an alternative embodiment of invention utilizing a pin style set screw 25, which is installed through the pinslot 26 of the insert 40 and tightened against the opposing wall of the tool holder tool pocket 62.

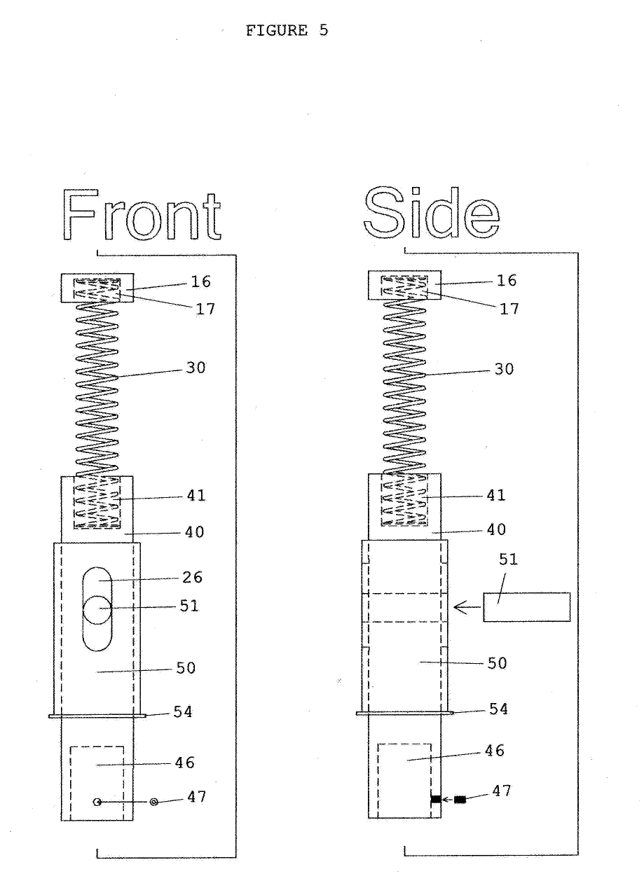

FIG. 5 is a front and side detail view of an alternative embodiment of the invention utilizing a sleeve 50 and snap ring 54 replacing the set screw 20 for retention of the invention into a r8-tool holder 12. An r8-tool holder 12 needs to be drawn into a machines spindle to apply retention pressure on the tool 60. The snap ring 54 and sleeve 50 alternative allows the tool 60 to be installed into the r8-tool holder 12, without falling out of the r8-tool holder 12 while not installed into spindle of machine. This is especially useful when a machine using r8-tool holder 12 has a tool 60 changer, the tools will not fall out while in storage in the tool 60 changer waiting to be used

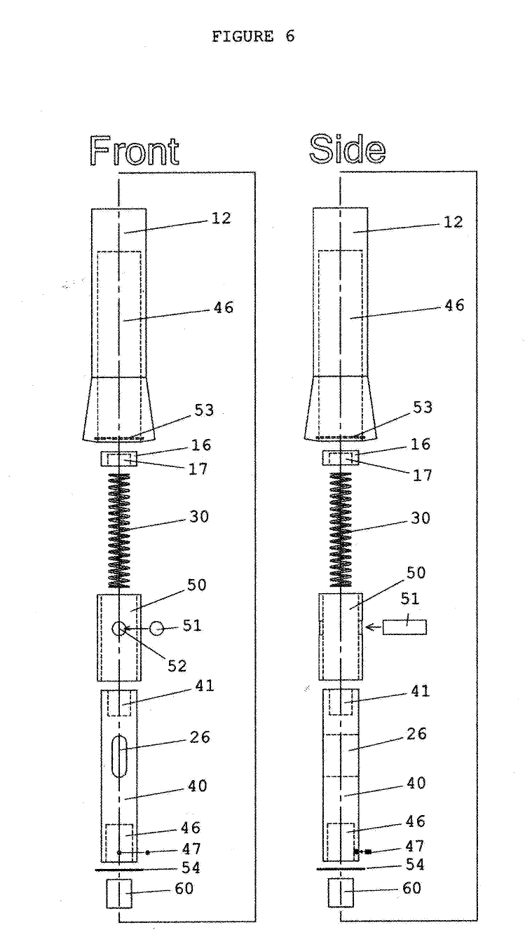

FIG. 6 is an exploded front and side view of an alternative embodiment of the invention showing the order of assembly into a r8-tool holder 12, utilizing a sleeve 50, a snap ring 54, and a snap ring slot 53 for retention. To assemble, push the spring stop 16 into the r8-tool holder tool pocket 62 followed by the spring 30. Slip insert 40 into sleeve 50 align the pin 51 slot and the pin hole 52 and insert 40 pin 51 than using the palm of your hand push the insert 40 with sleeve 50 attached into r8-tool holder 12 deep enough to expose the snap ring slot 53 that has been machined into the r8-tool holder 12 and install snap ring 54 and release pressure. The snap ring 54 will hold it in place. Than install the tool 60.

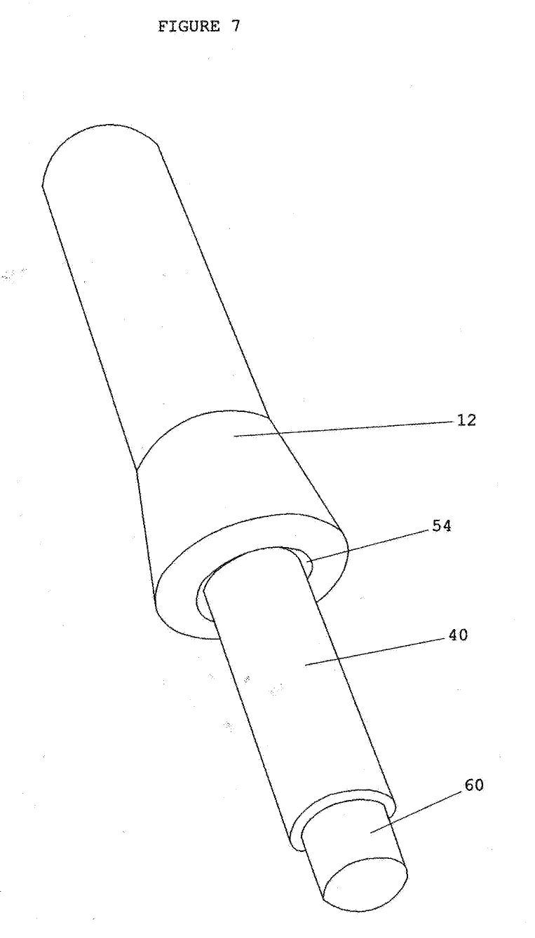

FIG. 7 is a perspective view of an alternative embodiment of the invention utilizing a sleeve 50 and snap ring 54 for retention, assembled into a r8 tool holder 11.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A spring loading insert for spring loading a tool inside of a tool holder, comprising:
an oblong end, threaded set screw, for retention and control of insert in tool holder;
a compression spring, for applying outward pressure on the insert;
a softer than steel, slick insert, for interfacing between spring and tool, capacitively engaged to said spring, and freely connected to said set screw;
an insert set screw pocket, for retention and control of insert in spindle taper;
a pin shaped end, threaded pin style set screw, for retention and control of insert in spindle taper;
a pinslot, for retention and control of insert in spindle taper;
an internal snap ring slot, for retention of snap ring and insert into tool holder;
a tubular sleeve, for interfacing between and providing retention and control of the insert in the r8-tool holder;
a pin, for retention and control of the insert in the sleeve;
a pin hole, for installation of pin in sleeve for retention and control of insert; and
an internal snap ring, for retention of sleeve into r8-tool holder.
